(19) United States
(12) Patent Application Publication
(10) Pub. No.: US 2010/0153247 A1
(43) Pub. Date: Jun. 17, 2010

(54) BALANCE EXCEPTION MANAGEMENT

(75) Inventors: Joanne DiPaolo, Matthews, NC (US); Bill Carey, Davidson, NC (US); Dan Caretta, Lake Wylie, SC (US); Brad Arrowood, Winston-Salem, NC (US); Jeanine Tabaczynski, Huntersville, NC (US)

Correspondence Address: Driggs, Hogg, Daugherty & Del Zoppo, 38500 Chardon Road, Willoughby Hills, OH, 44094, US

(73) Assignee: Wachovia Corporation, Charlotte, NC (US)

(21) Appl. No.: 12/335,056

(22) Filed: Dec. 15, 2008

(51) Int. Cl. G06Q 40/00; G06Q 30/00; G06N 5/02; G06F 17/00

(52) U.S. Cl. 705/34; 706/50

(57) ABSTRACT

Systems (and methodologies) that put consumers in control of NSF/OD (Not Sufficient Funds/Overdraft) fee management are provided. In accordance with the innovation, fees are solely dependent on time to cure a negative balance. In aspects, customers are charged a “per day” or “per diem” rate for NSF and/or OD conditions. By charging a per diem rate, customers are incentivized to cure a negative balance as the fee amount increases as time elapses throughout the balance exception cycle. Additionally, customers can be notified of balance exception situations. The notifications can sent based upon policies, preferences, rules or inferences.

### BACKGROUND

As NSF/OD (Not Sufficient Funds/Overdraft) fee revenue continues to grow, financial institutions have become increasingly dependent on this revenue. Unfortunately, consumers are most often not in control of fee management, or otherwise incentivized to cure NSF/OD conditions. This lack of control often leads to dissatisfied customers and loss of revenue for the financial institution.

NSF/OD regulations, policies and practices have become a focal point of concern to numerous Congressional and Legislative bodies, creating both financial and reputational risk within the banking industry. Traditionally, NSF/OD policies are complex and sometimes difficult to explain. Additionally, financial institutions' posting order and hold policies often make it very difficult for customer service representatives to re-create balance history and charging routines, thus creating a disjointed service process and an overall poor customer experience.

Given the current NSF/OD policies and procedures and the state of the current economy, financial institutions have an opportunity to revolutionize the manner in which NSF/OD fees are assessed. Thus, innovative and leading edge financial institutions can potentially guide the industry with more consumer favorable practices with respect to NSF/OD fee assessment.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises systems (and methodologies) that put consumers in control of NSF/OD (Not Sufficient Funds/Overdraft) fee management, where fees are solely dependent on time to cure a negative balance. In accordance with aspects of the innovation, customers will be agnostic to posting order and the impact of “holds” will be a moot point.

In accordance with the innovation, customers are charged a “per day” or “per diem” rate for NSF and/or OD conditions. By charging a per diem rate, customers are incentivized to cure a negative balance as the fee amount increases as time elapses throughout the balance exception cycle. Rules, thresholds and limits can be employed as appropriate or desired. For example, a negative balance of a set nominal amount (e.g., three dollars) can be set to be within an acceptable threshold thereby not triggering an NSF/OD balance exception condition.

In accordance with balance exception situations, customers can be notified in a variety of manners or by a variety of modalities. More particularly, customers are able to personalize the notification preferences related to NSF/OD balance exception situations. This personalization can enable expeditious notification and subsequent cure. By way of example, a customer can opt to receive notifications via electronic mail (aka email), text messaging (SMS (short message service)), instant message (IM), conventional paper mail, telephone, VoIP (voice-over-Internet Protocol), etc.

In yet another aspect thereof, a machine learning & reasoning (MLR) component is provided that employs a probabilistic and/or statistical-based analysis to prognose or infer an action that a user desires to be automatically performed. For instance, MLR logic can be employed to select a notification modality based upon context (e.g., time, date, location, activity) of a customer.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example block diagram of a fee management system that establishes a customer-centric approach to balance exception fees in accordance with aspects of the innovation.

FIG. 2 illustrates an example flow chart of procedures that facilitate management of NSF/OD (insufficient funds/overdrafts) in accordance with an aspect of the innovation.

FIG. 3 illustrates an example flow chart of procedures that facilitate administering a per diem or daily fee in accordance with aspects of the innovation.

FIG. 4 illustrates an example block diagram of a fee accrual administration component in accordance with an aspect of the innovation.

FIG. 5 illustrates an example block diagram of a fee assessment component in accordance with an aspect of the innovation.

FIG. 6 illustrates an example block diagram of an activity monitor component in accordance with an aspect of the innovation.

FIG. 7 illustrates an example block diagram of a notification administration component in accordance with an aspect of the innovation.

FIG. 8 illustrates an example block diagram of a notification administration component that employs a modality selection component and a confirmation component to effect notifications in accordance with aspects of the innovation.

FIG. 9 illustrates an example architecture that includes a machine learning & reasoning component that automates functionality in accordance with an aspect of the novel innovation.

FIG. 10 illustrates a block diagram of a computer operable to execute the disclosed architecture.

FIG. 11 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The following terms are used throughout the description, the definitions of which are provided herein to assist in understanding various aspects of the subject innovation. It is to be understood that these terms are not intended to limit the scope of the innovation described herein or recited in the claims appended hereto.

The term Balance Exception is used to describe a negative balance and/or other account conditions which trigger an OD (overdraft) or NSF (insufficient funds) fee assessment.

A Balance Exception Notification describes a notification that can be issued each business day (or other frequency) a retail consumer account has a balance exception condition due to additional activity causing overdrafts or items that reject NSF.

A Balance Exception Fee (BEF) is a daily fee issued when an account has a Negative Balance and/or Item(s) rejected due to NSF.

A Balance Exception Cycle is the period of time from when the account has a negative ledger balance and/or a returned item to the day the account has deposited funds and brought the account positive and/or has no items rejected NSF items.

NSF refers to situations where an item is rejected due to no funds available.

OD refers to an overdraft to an account or a negative ledger balance.

UAV refers to unavailable funds due to holds and when a ledger balance is not negative.

Notification Preferences are described to convey options given to customers where they can specify how and/or when they would like to receive notifications. These detailed contact identifiers are Notification Preferences and can be certain combinations of: email address, text message address, phone number (for contact by Dialer), U.S. Postal mailing address, among others.

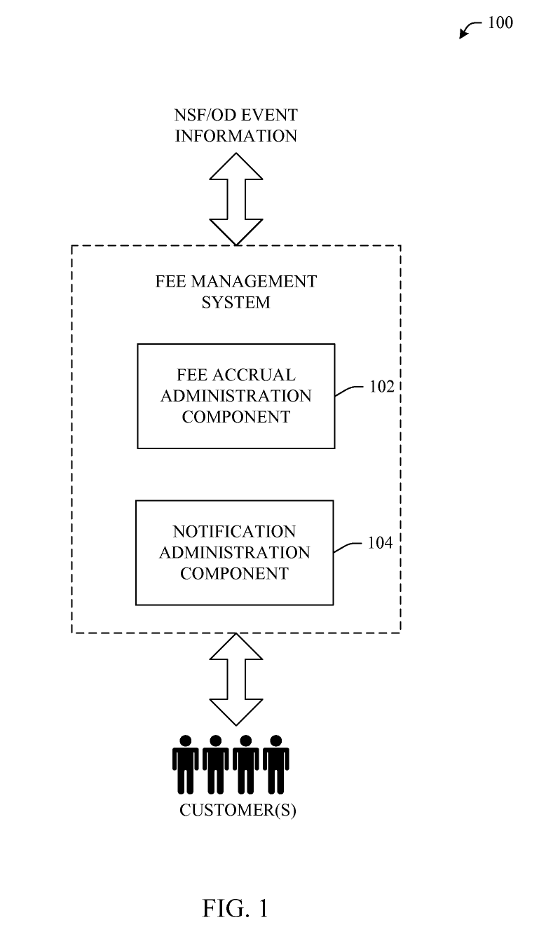

Referring initially to the drawings, FIG. 1 illustrates a system 100 that describes a customer-centric approach to avoid, alleviate and/or cure balance exception conditions, such as NSF and OD situations. As a result of financial and reputational risks associated with NSF/OD policies and practices, the innovation discloses customer-centric approaches that enable customers manage assessment of NSF/OD fees.

As illustrated, system 100 generally includes a fee accrual administration component 102 and a notification administration component 104. While each of these sub-components is illustrated integral to the fee management system 100, it is to be understood that each of these sub-components 102, 104 describes a key focus of the innovation. In other words, while used in tandem to promote a customer-centric fee management system, each of these sub-components employs features, functions and benefits unique to a particular portion of the innovation. It is to be understood that the per diem fee assessment as described herein related to the fee accrual administration component 102 can be employed as a stand-alone system or business method. It is also to be understood that the notification administration component 104 can be employed to convey balance exception situations to a customer so as to provide the customer an opportunity to cure or dispute the situation as appropriate.

As described above, the system 100 facilitates charging a daily negative balance exception (NSF/OD) fee as opposed to the traditionally imposed per item fees. The daily charge puts the customer in control and therefore incentivizes them to cure the fee to eliminate any further daily increase for an unpaid negative balance. As can be understood that, in addition to generating positive market perception, the innovation alleviates instances where a small number of OD items or low dollar items create exorbitant fees. While aspects described herein employ a daily fee cycle, it is to be understood that other aspects can employ other time periods without departing from the spirit and/or scope of the innovation.

Among the other benefits described herein, the innovation eliminates ‘Double Dip’ situations. It will be appreciated that a double dip occurs when a debit card transaction creates two separate OD fees: 1) when a debit card hold reduces the available balance creating an OD upon other items posting; and 2) what the debit card hold is released, the transaction posts and creates another OD. Here, system 100 (and corresponding methodologies) eliminates this situation by applying a single daily (or periodic) fee regardless of the number of balance exception items.

Together, the fee accrual administration component 102 and the notification administration component 104 establish a mechanism by which customers can be kept informed of balance exception situations which have (or potentially may) result in daily balance exception fees. In operation, the fee accrual administration component 102 detects balance exception situations and assesses fees associated therewith. As described above, the fee assessed can be based upon a daily activity cycle and not a traditional per item scenario. In other words, a single fee (e.g., $29) can be assessed regardless of the number of balance exception items in a single day.

Further, the fee accrual administration component 102 can monitor payments which cure the negative balance. Accordingly, if cured, the balance can be adjusted appropriate. Similarly, if not cured, additional fees can accrue (e.g., subject to a cap) each day the negative amount is not cured. This accrual or modification of balance exception fees can also be facilitated by the fee accrual administration component 102.

The notification administration component 104 configures and transmits notifications to customers which inform them of balance exception situations, fees assessed, fees cured, etc. As described in greater detail below, a customer can select or define preferences by which notifications are configured and/or sent. In alternative embodiments, the notification administration component 104 can employ rules or other logic that effectively modifies preferences and/or policies based upon user state or context.

Essentially, the sub-components 102, 104 enable the fee management system 100 which establishes a customer-centric fee management system. In other words, rather than assessing a per item fee consistent with conventional systems, the subject innovation shifts control of curing fees (e.g., NSF/OD fees) to the customer. In particular aspects, the innovation provides systems and mechanisms that notify customers of balance exception situations which are current, pending, imminent, cured, etc. As described herein, customers can select, define or otherwise program notification preferences.

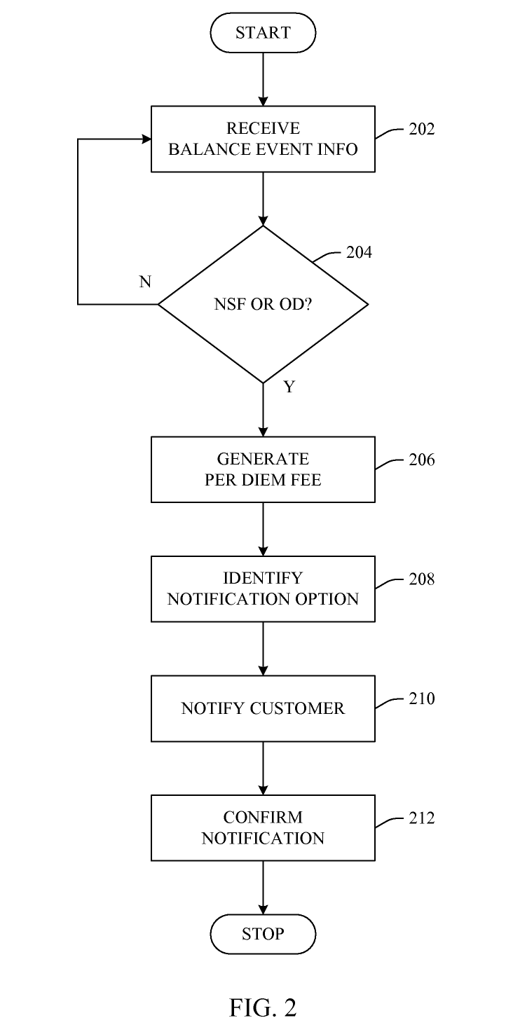

FIG. 2 illustrates a methodology of managing NSF/OD fees in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

Referring to FIG. 2, at 202, balance event information is received. For instance, balance event information can be received and analyzed to determine if a balance exception event occurred. More particularly, at 204, a determination is made to establish if an NSF or OD situation occurred. If a balance exception (e.g., negative balance) is determined to not have occurred, the methodology returns to 202 to monitor additional balance event information.

If an NSF or OD balance exception is determined to have occurred at 204, a per diem (e.g., daily) fee is generated at 206. In one example, this fee is a flat fee of $29. It will be appreciated that this per diem fee can be easily distinguished from conventional practices of assessing a per item fee. For example, the per diem fee of the subject innovation does not penalize a customer for multiple balance exceptions that arise out of a single balance mismanagement situation. Additionally, the per diem fee incentivizes the customer to cure the fee. If not cured, the fee will continue to accrue each day that the fee goes unpaid or uncured.

At 208, a notification option is identified based upon most any factor, including but not limited to, customer generated rule/preference, organizational policy, or the like. In addition to user or organizational policy/preference, the notification option can be selected based upon type or amount of balance exception, among others.

At 210, the customer can be notified, for example, of the balance exception, acknowledgement of cure, etc. As will be described in greater detail below, the notice can be transmitted or conveyed in most any suitable manner, including but not limited to, electronic mail, instant message, text message (e.g., SMS (short message service), voice call, automated call, paper delivery, etc. To ensure communication, confirmation is effected at 212 for example, by way of delivery receipt.

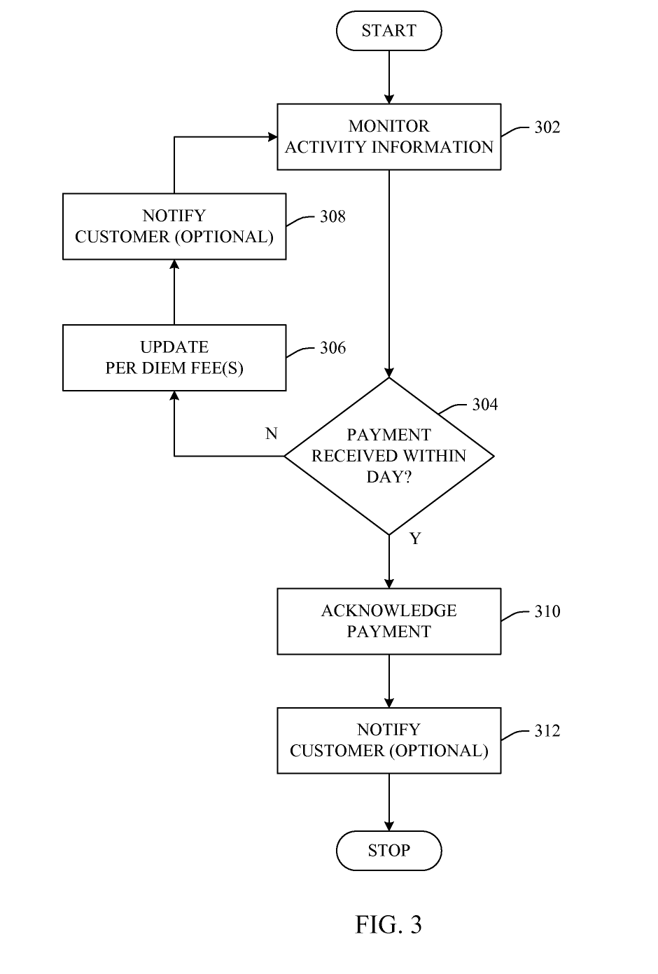

Referring now to FIG. 3, there is illustrated a methodology of administrating a per diem or daily fee in accordance with aspects of the innovation. As described above, upon identification of a balance exception, a daily fee can be assessed regardless of the number of items (e.g., withdrawals, checks, . . . ) involved in the exception which spans the duration of a day (or some other designated period of time). It will be understood that, so long as regulatory standards and policies permit, the innovation contemplates aspects in which the fee is commensurate with the amount of exception, type of activity or instrument that effected the exception, etc. These alternative aspects are to be included within the scope of this disclosure and claims appended hereto.

At 302, activity information can be monitored. For example, payment information can be monitored in real time (or near real time) to enhance accuracy and effectiveness of the innovation. In other aspects, payment information can be monitored on a scheduled basis such that information related to a customer's account(s) is reviewed daily, hourly, etc. as appropriate or desired. By monitoring activity information and history, the methodology can capture information related to payments, deposits, transfers, etc. which can offset or potentially cure outstanding balance exception situations.

At 304, a determination is made to establish if a payment (e.g., deposit, transfer) has been received with regard to an account in a balance exception situation. In accordance with the aspect described, a determination is made to establish if a payment or other positive balance activity took place within the current day. If not, the existing per diem fee(s) is increased at 306 in accordance with a prescribed schedule. By way of example, an initial $29 fee can be charged upon detection of a balance exception. Thereafter, an additional $29 fee (or other designated amount) can be charged for each subsequent day that the balance exception fee goes uncured. In particular examples, the innovation contemplates a maximum fee which can be based upon a maximum time elapsed prior to cure, for example, 5 days.

Upon updating the per diem fee(s), notification can be optionally sent as indicated at 308. In other words, a notification in accordance with predefined policies can be sent to a customer at 308. Additionally, the optional notification can be confirmed (not shown) as described with regard to FIG. 2.

If, at 304, payment is deemed received, at 310 the payment can be acknowledged. For instance, upon acknowledgement, the balance exception fee can be removed thereby eliminating potential of fee increase(s). At 312, notification of abolition of the fee can be sent at 312. As described above, transmission and receipt of the notification can be confirmed (not shown) as described above.

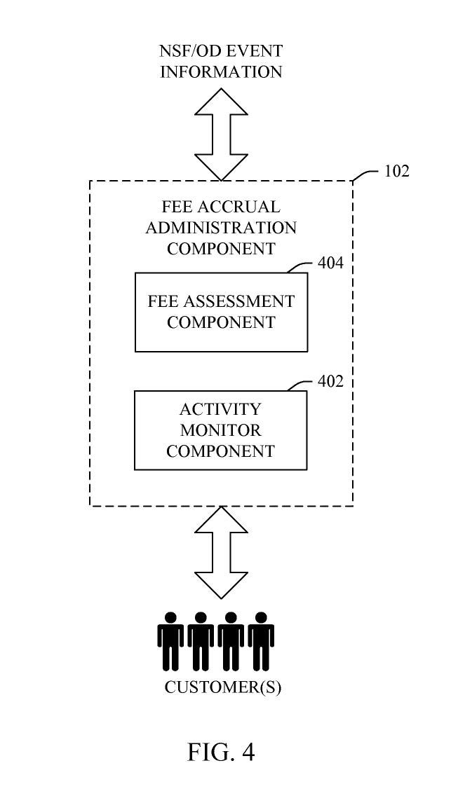

Turning now to FIG. 4, a block diagram of an example fee accrual administration component 102 is shown in accordance with an aspect of the innovation. As shown, the fee accrual administration component 102 can include an activity monitor component 402 and a fee assessment component 404. Together, these sub-components (402, 404) enable initial balance exception fee assessment as well as recurring fee assessment(s). As described in accordance with the methodologies of FIGS. 2 and 3, daily (or other periodic) fees can be assessed based upon most any balance exception. As payments (e.g., deposits, transfers) occur to cure outstanding fees, fees can be adjusted or eliminated as appropriate. Similarly, as fees remain outstanding for the duration of a cycle (e.g., day), additional balance exception fees can accrue.

In operation, the activity monitor component 402 can monitor customer activity in real time (or near real time). Here, deposits, transfers and other payments can be monitored as they relate to customer's accounts. The fee assessment component 404 can be used to evaluate the activity and to make determinations with regard to balance exception fees. More particularly, the fee assessment component 404 can be used to establish whether or not to initiate a balance exception fee. Alternatively, the fee assessment component 404 can be employed to establish whether or not to increase, decrease or otherwise extinguish an outstanding balance exception fee.

The sub-components (402, 404) of the fee accrual administration component 102 essentially puts consumers in the driver seat with regard to fee management, for example, fees are solely dependent on time to cure a negative balance. Thus, in accordance with the innovation, customers will be agnostic to posting order and the impact of “holds” will be a moot point.

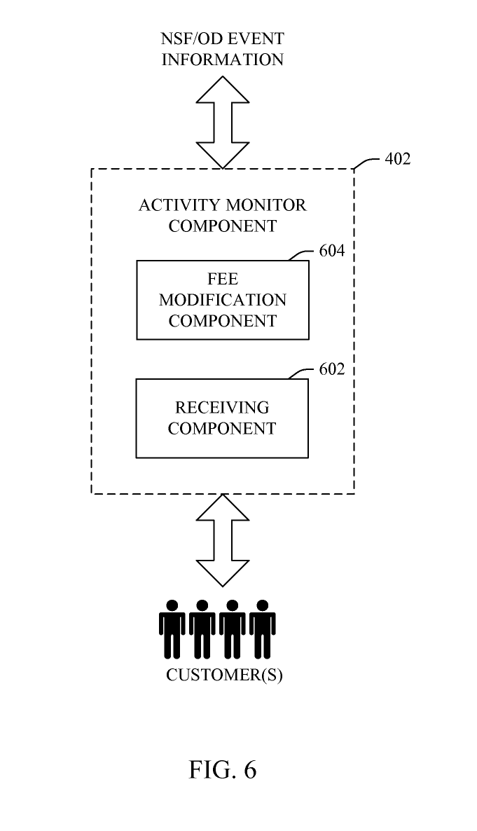

Additionally, as discussed above and in more detail with regard to FIG. 6 that follows, customers are able to personalize notification preferences in balance exception or NSF/OD situations. This personalization will enable expeditious notification and should prompt subsequent cure as customers would not want fees to accrue. By way of example, a customer can opt to receive notifications via email, text messaging (SMS), instant messaging (IM), conventional paper mail, telephone, etc.

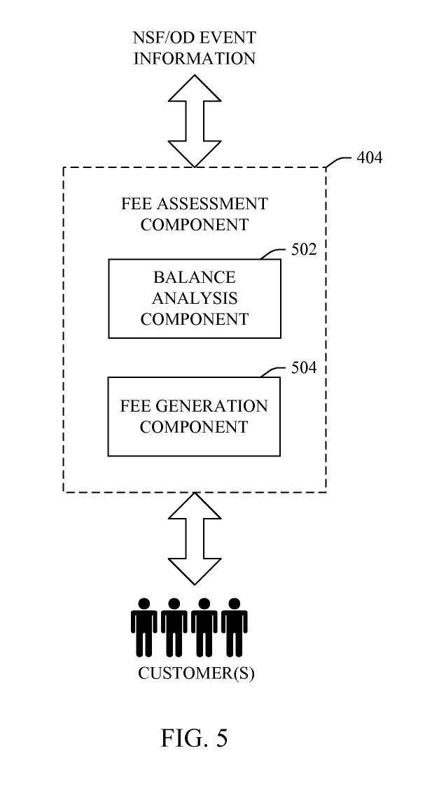

Turning now to a discussion of FIG. 5, illustrated is a block diagram of an example fee assessment component 404 in accordance with an aspect of the innovation. The component 404 can include a balance analysis component 502 and a fee generation component 504. In accordance with the aforementioned systems and methodologies, these subcomponents (502, 504) enable real time (or near real time) monitoring of account balances and transactions in order to identify negative balance exceptions or changes in balances that warrant a cure in balance exceptions.

The balance analysis component 502 dynamically monitors account balance(s) in order to determine when/if a fee exception situation exists. As described supra, should a fee exception exist, the innovation describes assessment of a daily or per diem rate based upon the existence of a negative balance. Rather than assessing a fee based upon the number of items (e.g., bounced checks, ODs, . . . ) the innovation merely charges a single fee which increases as time elapses without cure. It will be appreciated that this change in practice from that of traditional approaches shifts the burden and control to the customer to cure situations—which benefits both the customer and the financial institution.

Conventionally, Overdrafts (ODs), Insufficient Funds (NSF), and Unavailable Funds Fees are assessed for each item that posts or attempts to post against insufficient funds. The subject innovation eliminates per item fees. Rather, a Balance Exception Fee is charged for each business day (or other designated time period) an account is overdrawn and/or items are rejected due to insufficient funds.

The fee generation component 504 can establish the exception fee amount—for example, in one aspect, the per diem fee is set to $29/day. Other aspects can employ differing fee structures and amounts without departing from the spirit and/or scope of the innovation and claims appended hereto. Management of the fee following initial assessment is managed by way of the activity monitor component 402.

Referring now to FIG. 6, an example block diagram of an activity monitor component 402 is shown. In operation, the activity monitor component 402 employs a receiving component 602 and a fee modification component 604 to monitor account activity while updating (e.g., increasing, eliminating) negative balance exception fees based upon activity. Together, the sub-components (602, 604) facilitate real time (or near real time) fee management.

The receiving component 602 collects, accesses or otherwise obtains information related to activity regarding a particular account. In aspects, this information can be received by way of a direct data communications feed. Other aspects can gather information in a batch or scheduled manner. It is to be understood that the innovation contemplates most any mechanisms of receiving information in the form of account or activity data without departing from the scope of the innovation described herein.

The fee modification component 604 can process the information in order to effectively manage negative balance exception fees. In other words, the fee modification component 604 manages the fee based at least in part upon time elapsed during a negative balance exception situation (e.g., balance exception cycle). The data and other information gathered by way of the receiving component 602 can be used by the fee modification component 604 to increase or otherwise deem the fee as satisfied as appropriate.

The subject innovation modifies conventional approaches of charging a per item fee for negative balance situations. Conventionally, OD, NSF, and Unavailable Funds Fees are assessed for each item that posts or attempts to post against insufficient funds in a customer's account. In contrast to these conventional approaches, the subject innovation eliminates per item fees and instead charges a balance exception fee for each business day (or other defined period) that an account is overdrawn (OD) and/or items are rejected due to insufficient funds (NSF).

As described in greater detail infra, in aspects, customers (e.g., retail customers) will be able to select a method, modality or means of receiving notifications with regard to balance exception situations. These options can include, but are not limited to, electronic mail, text message (SMS), and/or telephone. As an added benefit, customers can opt to not receive postal notifications if they choose an electronic notification method.

The innovation provides for elimination of per item NSF, UAV and OD fees. In doing so, a daily balance exception fee is introduced and disclosed herein. In one example, the balance exception fee equals $29 for each day a customer has a negative balance and/or a rejected NSF item. In additional aspects, the balance exception fee can be capped at X days (e.g., 10 consecutive business days) per balance exception cycle. A balance exception cycle defines the number of consecutive business days with NSF and/or Negative Balance. In other aspects, the fee can be capped at a predetermined amount, for example $290.

To enhance efficiency and effectiveness, the innovation can consider and/or employ a low dollar negative balance exception waiver threshold. For example, if the negative balance is less than or equal to −$3, no balance exception fee is triggered on the first day of a balance exception cycle. Rather, the customer can be notified of the negative balance condition.

In aspects, the innovation removes holds for consideration of charging a balance exception fee. Additionally, check card holds (soft holds) from consideration in posting of transaction can also be removed. The posting order can be revised from a conventional order to minimize risk. Following is an example revised posting order:
Credits first
Non-returnable debits (Ascending dollar order) (i.e. non-check debits),
Returnable checks in serial number order (Physical and electronic debits)
Bank Fees

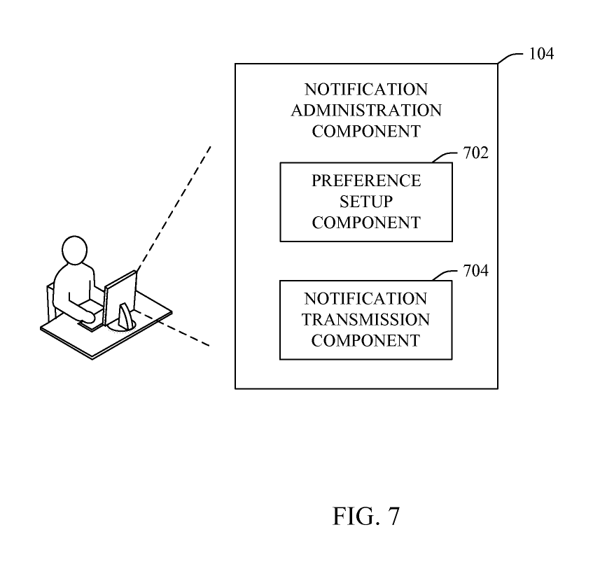

As will be described in detail with regard to FIG. 7 below, the innovation provides an expedited means of notifying customer of a balance exception situation. Additionally, the innovation implements improved and ongoing banker education to ensure flawless service execution.

The innovation can employ a number of rollout considerations. For example, rollout of the described per diem approach can be phased in by the organization across customer accounts. Upon rollout, accounts with a positive ledger balance will most often not be assessed a fee until they start a balance exception cycle. Those with a negative ledger balance upon rollout will only be assessed the daily fee when new activity posts to the account making the account more negative or when and item is NSF. It is to be understood that this activity triggers the balance exception cycle and sets number of days to 1. Customers will be able to select means for balance exception notifications upon rollout as well as to modify means for notification as desired.

Turning now to FIG. 7, a block diagram of an example notification administration component 104 is shown. Generally, this component 104 can include a preference setup component 702 and a notification transmission component 704. Together, these sub-components (702, 704) facilitate setup and transmission of balance exception notifications. As described above, these notifications can be sent to customers such that the customers can be incentivized or compelled to cure balance exceptions before fees are posted. In other words, the innovation can enable the customer to post payments or funds that cure balance exceptions prior to the initial exception fee posting as well as additional exception fees throughout the balance exception fee cycle.

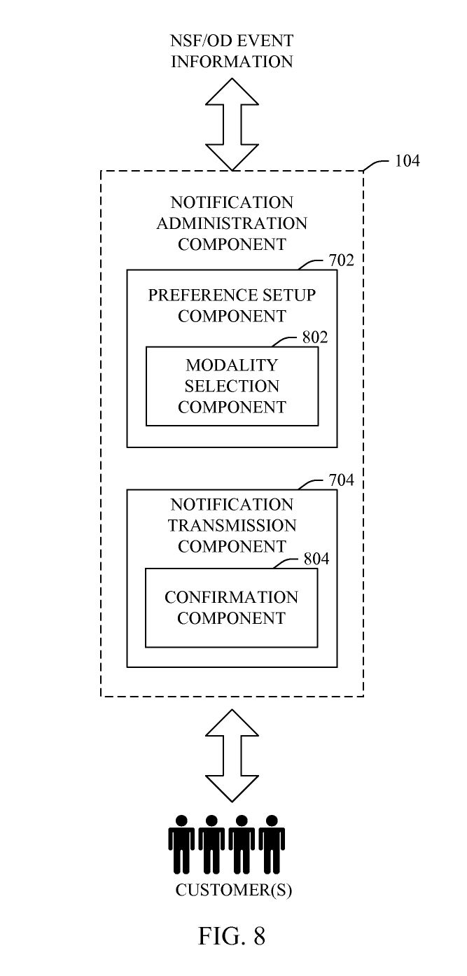

As illustrated in FIG. 8, the preference setup component 702 can include a modality selection component 802. In operation, a customer (or other entity) can employ the modality selection component 802 to structure rules, policies or preferences related to the management of balance exception notifications. For instance, rules can be configured to govern which modality or group of modalities are employed to send balance exception notifications. In aspects, modalities such as electronic mail, text message, instant message, voice call, pre-recorded dialer call, paper delivery, etc. can be employed to convey the notification to a customer.

In addition to selection of the preferred notification modalities, notification parameters such as, but not limited to, when to select a modality based upon time of day, amount of exception, type of activity that triggered the exception, etc. can be configured by way of the modality selection component 802.

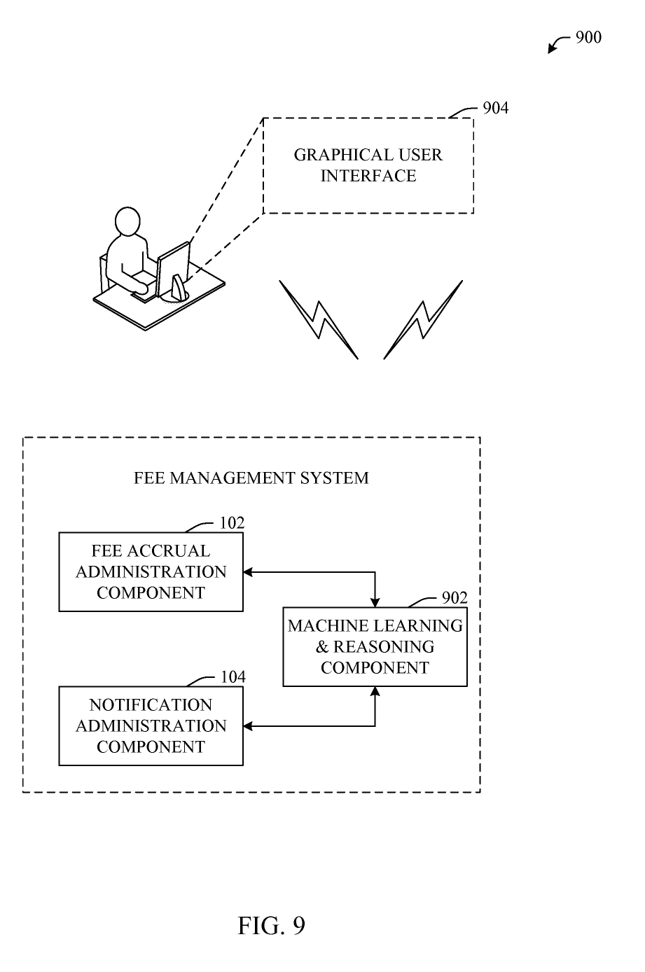

With continued reference to FIG. 8, the notification transmission component 704 can be employed to effect communication or conveyance of the balance exception information to a customer (or other designated entity). The notification transmission component 704 employs the modality (or group of modalities) designated by way of the modality selection component 802. In operation, the notification transmission component 704 can determine the appropriate modalities based upon a predefined set of rules, preferences or policies. In other examples, as described with regard to FIG. 9 that follows, machine learning & reasoning (MLR) mechanisms and logic can be employed to automatically select an appropriate notification modality (or group of modalities) based upon contextual factors.

To enhance accuracy and effectiveness of the innovation, a confirmation component 804 can be employed so as to confirm delivery of a balance exception notification. As will be appreciated, if the notification is bounced or not received for some other reason, effectiveness of the system can be compromised. In other words, since fees are generated and incremented based upon time elapsed, it is important that notifications are timely received. Thus, the confirmation component 804 can be employed to ensure timely communication of notifications concerning balance exceptions.

In aspects of the innovation, notification types and frequency can be as follows in the table below:

| | Notification Types | Frequency | Format | Time |
|---|---|---|---|---|
| 1 | Overdraft | When and | Paper/Electronic | Electronic: 1 |
| | Protection Transfer | overdraft | | pm EST or 1 |
| | Notice | protection transfer | | pm MST Paper: |
| | | is performed (no | | As is today |
| | | change from | | |
| | | current state) | | |
| 2 | Balance Exception | Any day where | Paper/Electronic | Electronic: |
| | Notification (NSF) | there is a | | After final |
| | | paid/returned item | | account |
| | | due to insufficient | | decision, 1 pm |
| | | funds | | EST Paper: As is today |
| 3 | Balance Exception | Any day where an | Paper/Electronic | Electronic: 9 |
| | Notification (OD) | item is paid into | | am EST or 9 am |
| | | overdraft | | MST Paper: as |
| | | | | is today |
| 4 | Balance Exception | Each day of the | Paper/Electronic | Electronic: 1st |
| | Notification (OD/ | Balance Exception | | notice with |
| | NSF) | Cycle customer | | overdraft |
| | | has this condition | | information and |
| | | | | “special |
| | | | | message” will |
| | | | | be sent at 9 am |
| | | | | EST or 9 am |
| | | | | MST, 2nd |
| | | | | notice will be |
| | | | | sent after final |
| | | | | account |
| | | | | decision is |
| | | | | complete, 1 pm |
| | | | | EST. Paper: |
| | | | | sent once final |
| | | | | NSF decision is |
| | | | | complete |
| 5 | Notification | Upon section | Electronic | Any Time |
| | Preference | electronic | | |
| | Confirmation | notification | | |
| | | preference | | |
| 6 | Balance Threshold | Only the first day | Electronic | Electronic: 9 |
| | Notification | of Balance | | am EST and 9 |
| | | Exception Cycle if | | am MST, No |
| | | the ledger balance | | Paper |
| | | is between $0--$3 | | |
| 7 | Bounce Back | When electronic | Electronic/Paper | Any Time |
| | Notification | notification is | | |
| | | undeliverable | | |
| 8 | Update Preference | When changes or | Electronic | Any Time |
| | Notification | updates are made | | |
| | | to customer | | |
| | | contact | | |
| | | information | | |

It is to be understood that if electronic confirmation is not possible or if confirmation indicates undeliverable, notification will be sent via paper delivery. When there is a bounce back of a balance exception or Overdraft Protection Transfer Notice, the bounce back can be escalated to other contact identities (IDs) on file so as to effect timely and confirmed notification delivery. The balance exception or Overdraft Protection Notice can be sent along with a message to update preferences.

When there are no other Contact IDs on file for escalation, a paper Bounce Back Notification can be sent. If contact ID escalation is not successful then notification can be sent via standard delivery mail and notification preference can be changed to paper. In aspects, modifications to contact IDs (e.g., additions or changes to contact information) will trigger a Notification Preference Confirmation to new preference and an Update Preference Notification to old preference. Changes to contact IDs will generate a change Contact ID Message (e.g., for electronic mail).

As described above, if a customer's Contact ID status is undeliverable then the message can be delivered though other contact IDs on file. If no other contact ID delivery is successful then a paper notification can be sent via postal mail. The innovation is capable of retaining contact history as well as a log of notifications sent via a variety of modalities. The innovation contemplates a notification preference to be automatically set to paper delivery upon opening of a new account and/or cancelling/re-opening of an account—thus, in aspects, a customer will have to select alternative delivery options (e.g., modalities) as desired.

FIG. 9 illustrates a system 900 that employs a machine learning & reasoning component 902 which facilitates automating one or more features in accordance with the subject innovation. The subject innovation (e.g., in connection with modality selection) can employ various MLR-based schemes for carrying out various aspects thereof. For example, a process for determining which modality as a function of user context can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria which notification modality (e.g., electronic mail, text message, instant message, telephone, Dialer) to select based at least in part upon a user location, date, time of day, calendared appointments, engaged activity (aka ‘context’).

By way of example, as described supra, a customer can employ a graphical user interface 904 to define rules, preferences, policies related to notifications. Additionally, the customer can enable access to or otherwise grant permissions to their calendar (e.g., Lotus Notes, Outlook, . . . ). Thus, the system 900 can employ MLR logic (902) to infer a delivery notification preference based upon user context at the time of delivery notification or balance exception situation. In other aspects, the MLR component 902 is capable of selecting a notification modality based upon most any factor, including but not limited to, balance exception triggering conditions (e.g., NSF, OD), length of balance exception cycle, etc. For instance, if the cycle exceeds a set number of days, e.g., 5, the MLR component 902 can automatically escalate notification, for example, from electronic mail to text message, etc. It is to be understood that notification escalation order can also be preprogrammed as appropriate or desired (e.g., rules-based).

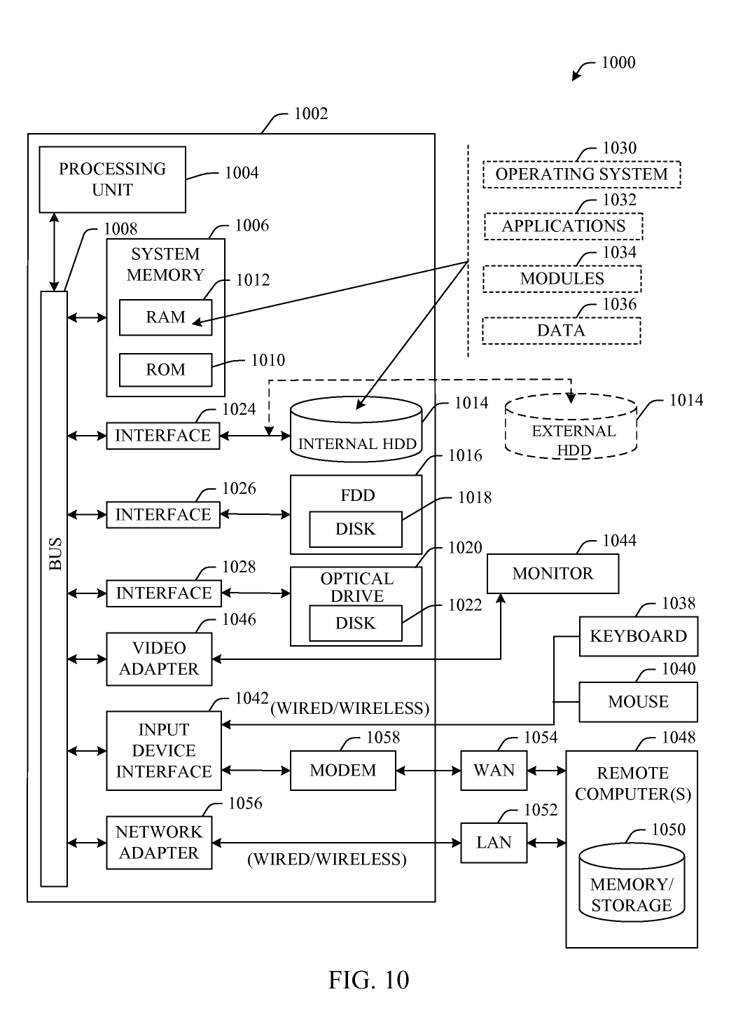

Referring now to FIG. 10, there is illustrated an example block diagram of a computer operable to execute the disclosed architecture. In order to provide additional context for various aspects of the subject innovation, FIG. 10 and the following discussion are intended to provide a brief, general description of a suitable computing environment 1000 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the exemplary environment 1000 for implementing various aspects of the innovation includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the innovation can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

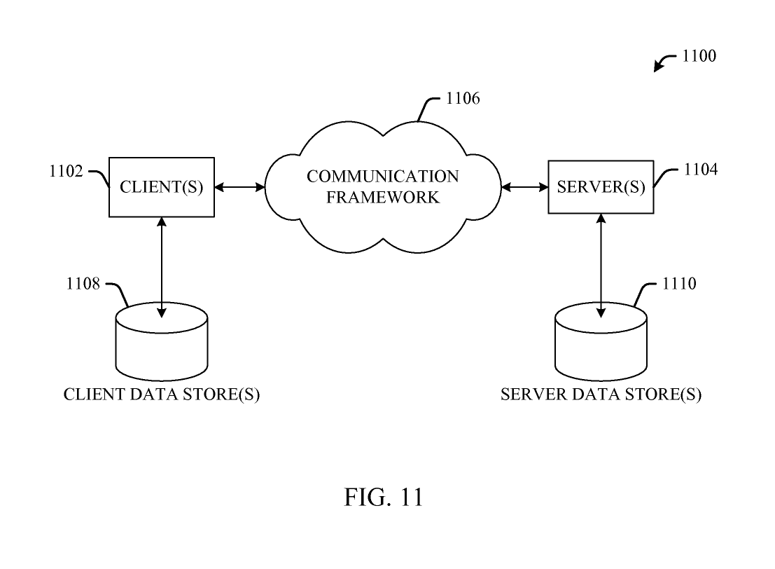

Referring now to FIG. 11, there is illustrated a schematic block diagram of an exemplary computing environment 1100 in accordance with the subject innovation. The system 1100 includes one or more client(s) 1102. The client(s) 1102 can be hardware and/or software (e.g., threads, processes, computing devices). The client(s) 1102 can house cookie(s) and/or associated contextual information by employing the innovation, for example.

The system 1100 also includes one or more server(s) 1104. The server(s) 1104 can also be hardware and/or software (e.g., threads, processes, computing devices). The servers 1104 can house threads to perform transformations by employing the innovation, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system that facilitates balance exception fee management, comprising:
a memory having computer executable instructions stored thereon:
a processor that executes the computer executable instructions stored on the memory to implement the following:
a fee accrual component that receives balance exception event information and generates a periodic fee upon determination of a balance exception event that exceeds a predetermined threshold, wherein the periodic fee is assessed upon a financial account.

2. The system of claim 1, wherein the periodic fee is a per diem fee that increases in a fixed amount daily throughout a fee exception cycle.

3. The system of claim 2, the predetermined threshold is at least three U.S. dollars.

4. The system of claim 2, the balance exception event information relates to at least one of an NSF (Not Sufficient Funds) or an OD (Overdraft) event.

5. The system of claim 2, further comprising a fee assessment component that charges the per diem fee to the financial account as a function of time defined by the fee exception cycle, wherein the per diem fee increases daily until the balance exception event is of an amount below the predetermined threshold.

6. The system of claim 5, further comprising a balance analysis component that triggers the per diem fee based upon determination of the balance exception event in view of the predetermined threshold.

7. The system of claim 5, further comprising a fee generation component that establishes an amount of the per diem fee based upon the duration of the balance exception cycle, wherein the balance exception cycle is calculated as a function of business days elapsed from initiation of the balance exception event.

8. The system of claim 5, further comprising a payment monitor component that tracks satisfaction of the per diem fee.

9. The system of claim 8, further comprising:
a receiving component that facilitates reception of a payment related to the per diem fee; and
a fee modification component that at least of one of increases or eliminates the per diem fee based at least upon existence of the payment.

10. The system of claim 1, further comprising a notification administration component that facilitates conveyance of a notification to a customer based at least in part upon the balance exception event information.

11. The system of claim 10, further comprising:
a preference setup component that enables the customer to designate a modality for receipt of the notification; and
a transmission component that conveys the notification via the designated modality.

12. The system of claim 11, further comprising a modality selection component that chooses the modality based at least in part upon one of a predefined policy, rule, preference or context of the customer.

13. The system of claim 11, further comprising a confirmation component that validates transmission and receipt of the notification.

14. The system of claim 0, further comprising a machine learning & reasoning (MLR) component that employs at least one of a probabilistic and a statistical-based analysis that infers an action that a user desires to be automatically performed.

15. A computer-implemented method of managing balance exception fees, comprising:
a memory having computer executable instructions stored thereon;
a processor that executes the computer executable instructions stored on the memory to implement the following acts:
assessing a per diem balance exception fee as a function of a negative account balance that exceeds a threshold, whereas the per diem balance exception fee is charged via a fee accrual administration component; and
monitoring the negative account balance to incrementally increase the per diem balance exception fee by a fixed amount equal to the per diem balance exception fee based upon at least upon of duration of a balance exception cycle.

16. The computer-implemented method of claim 15, further comprising determining the per diem balance exception fee as a function of the duration of the balance exception cycle; wherein the threshold is at least three U.S. dollars.

17. The computer-implemented method of claim 15, further comprising notifying a customer of the negative account balance and the per diem balance exception fee.

18. The computer-implemented method of claim 17, wherein the notification is based at least upon one of a preference, policy, rule or inference.

19. A computer-executable system, comprising:
a memory having computer executable instructions stored thereon;
processor that executes the computer executable instructions stored on the memory to implement the following:
means for detecting a negative balance exception that exceeds a predetermined threshold, wherein the negative balance exception is triggered based upon one of an insufficient funds or overdraft event;
means for assessing a balance exception fee upon detection of the negative balance exception that exceeds the predetermined threshold; and
means for notifying a customer of the negative balance exception that exceeds the predetermined threshold and balance exception fee, wherein the balance exception fee increases by a fixed amount daily based upon duration of the negative balance exception that exceeds the predetermined threshold.

20. The computer-executable system of claim 19, further comprising means for increasing the balance exception fee based at least in part upon cycle duration of the negative balance exception; wherein the predetermined threshold is at least three U.S. dollars.
